(19) United States
(12) Patent Application Publication
(10) Pub. No.: US 2006/0068209 A1
(43) Pub. Date: Mar. 30, 2006

(54) Glass plate for display substrate

(75) Inventors: Motoyuki Hirose, Yokohama-shi (JP); Tetsuya Nakashima, Yokohama-shi (JP); Kei Maeda, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: ASAHI GLASS COMPANY, LIMITED, Tokyo (JP)

(21) Appl. No.: 11/280,258

(22) Filed: Nov. 17, 2005

Related U.S. Application Data
(63) Continuation of application No. PCT/JP04/07763, filed on May 28, 2004.

(30) Foreign Application Priority Data
May 30, 2003 (JP) 2003-155027

(51) Int. Cl. B32B 17/06; C03C 3/087

(52) U.S. Cl. 428/426; 501/70

(57) ABSTRACT

To provide a glass for a display substrate which has solved yellowing problems. A glass plate for a display substrate, which contains at least one member selected from the group consisting of Ti, Mn, Zn, Y, Nb, La, Ce and W in an amount of from 0.1 to 10 mass % as calculated as oxides.

### BACKGROUND OF THE INVENTION

1. Field of the Invention

The present invention relates to a glass substrate for display suitable for plasma display panels (PDP), field emission displays (FED), etc., particularly to a glass substrate for display which is produced by a float process.

2. Discussion of Background

In recent years, PDP as one type of thin flat plate type gas discharge display panels, has been widely used particularly for large-size flat television receivers, and its production volume is increasing. PDP comprises a front glass substrate, a rear glass substrate and barrier ribs to define and form cells and is designed to generate plasma discharge in the cells to let the phosphor layers in the inner walls of the cells emit lights thereby to form images.

For such a glass substrate for display, a float plate glass is used which can easily be large-sized and which is excellent in flatness and homogeneity. Such a float plate glass is a plate glass produced by a float process wherein a molten glass is sent from a melter onto a molten metal in a float bath wherein the molten metal such as molten tin is filled, and as it is transported as floated on the molten metal, it is formed into a plate glass, whereupon the plate glass is taken out and passed through an annealing furnace to obtain a plate glass. With such a float plate glass, since the atmosphere of the float bath in the process for its production is usually maintained to be a reducing atmosphere, the surface of the plate glass exposed to such a reducing atmosphere, is reduced, and the surface layer of the produced float plate glass is a layer having a high reducing state as compared to the inside thereof.

On a front glass substrate for PDP, transparent electrodes made of e.g. ITO (indium-doped tin oxide) are usually formed, and a silver paste is applied thereon by e.g. screen printing, followed by firing at a temperature of from 550 to 600° C. to form bus electrodes (bus-bar electrodes).

If a glass substrate made of conventional float plate glass is subjected to such treatment for forming bus electrodes, there will be a problem that the glass substrate tends to be colored yellow around the bus electrodes, whereby luminance or contrast of the image display will be deteriorated. This yellowing is considered to take place as follows. Namely, Ag ions diffused from the bus electrodes into the glass substrate, are reduced by Fe²⁺, Sn²⁺, etc. present in the diffused layer to Ag⁰, and colloid formed by aggregation of such Ag⁰ brings about yellow color emission.

It is known that Fe²⁺, Sn²⁺, etc. are present more stably in a glass having a high reducing state. For this reason, these ions are present in a larger amount in the vicinity of the surface of the float plate glass.

In the surface layer of the float plate glass, Sn attributable to the above mentioned molten tin is diffused. Especially, in the float plate glass surface which was in contact with the molten tin i.e. in the surface layer on the bottom side of the float plate glass, a large amount of Sn is diffused. Accordingly, if this bottom side is subjected to the above-mentioned treatment for forming bus electrodes, the above-mentioned yellowing will be more distinct. Usually, the above-mentioned treatment for forming bus electrodes is applied to the surface of the float plate glass which was not in contact with the molten tin, i.e. to the top surface of the float plate glass. However, there have been cases where Fe²⁺, Sn²⁺, etc. are present also in the top surface, thus leading to the above-mentioned problem of yellowing.

JP-A-10-255669 discloses a method of removing the above-mentioned surface layer having a high reducing state by polishing in order to avoid such a problem, but it is obvious that to remove the surface layer of a plate glass having a large surface area by polishing requires a substantial time and cost and remarkably decreases the production efficiency.

JP-A-11-11975 discloses a method for suppressing yellowing by silver by reducing the concentration of Fe₂O₃ contained in a glass. However, there is a problem that if Fe₂O₃ is reduced, the melting property of the glass deteriorates.

Further, JP-A-2001-213634 discloses a method for suppressing the above-mentioned yellowing by incorporating a halogen species in a glass. However, if a halogen-containing substrate glass is used, a degassing phenomenon is likely to take place in a vacuum evacuation step in the process for producing PDP, whereby the quality of the display will be substantially deteriorated.

### SUMMARY OF THE INVENTION

It is an object of the present invention to provide a glass plate for a display substrate which solves the above-mentioned problem of yellowing, particularly a glass plate for display substrate formed by a float process.

The present invention provides a glass plate for a display substrate, which contains at least one member selected from the group consisting of Ti, Mn, Zn, Y, Nb, La, Ce and W in an amount of from 0.1 to 10 mass % as calculated as oxides.

Further, the present invention provides such a glass plate for a display substrate which is a glass plate formed by a float process. Further, the present invention provides such a glass plate for a display substrate, wherein the reducing state of glass at the surface layer in a depth of 50 μm from the surface of the glass plate is higher than the reducing state of glass inside of the surface layer.

Further, the present invention provides such a glass plate for a display substrate, which is a glass plate consisting essentially of, as represented by mass %, from 45 to 72% of SiO₂, from 0 to 15% of Al₂O₃, from 6 to 24% of Li₂O+Na₂O+K₂O, from 4 to 31% of MgO+CaO+SrO+BaO, from 0 to 10.5% of ZrO₂, and from 0.1 to 10% of TiO₂+MnO₂+ZnO+Y₂O₃+Nb₂O₅+La₂O₃+CeO₂+WO₃.

The present inventors have found it possible to solve the above-mentioned problem of yellowing by using a glass plate which contains at least one member selected from the group consisting of Ti, Mn, Zn, Y, Nb, La, Ce and W, as a glass substrate for flat panel display such as PDP or FED.

### BRIEF DESCRIPTION OF THE DRAWINGS

FIG. 1 is a graph showing the absorbance curves of glass plates of Examples 1, 2 and 5 having a fired silver film removed.

### DETAILED DESCRIPTION OF THE PREFERRED EMBODIMENTS

The average linear expansion coefficient within a range of from 50 to 350° C. (the average linear expansion coefficient within a range of from 50 to 350° C. will hereinafter be referred to simply as the expansion coefficient) of the glass plate for a display substrate of the present invention, is preferably from 60×10⁻⁷ to 100×10⁻⁷/° C., more preferably from 70×10⁻⁷ to 90×10⁻⁷/° C., so that it matches the expansion coefficient of a fired product of glass frit to be used for the production of PDP, FED, etc.

The glass transition point (Tg) of the glass plate for the display substrate of the present invention is preferably at least 580° C. If the glass transition point is lower than 580° C., Ag ions tend to readily diffuse during the treatment for forming bus electrodes. The glass transition point is more preferably at least 600° C. In the following description, the glass transition point will be represented by Tg.

Further, the specific gravity at 20° C. of the glass plate for a display substrate of the present invention is preferably at most 2.9. If the specific gravity exceeds 2.9, the glass substrate tends to be too heavy. The specific gravity is more preferably at most 2.8, still further preferably at most 2.7, most preferably at most 2.6.

With respect to the glass plate for a display substrate of the present invention, the reducing state of the glass surface can be measured, for example, by measuring the concentration distribution of Fe²⁺ in the glass surface. Namely, Fe²⁺ is quantified by a dipyridyl absorptionmetry, and the total Fe ions i.e. Fe²⁺+Fe³⁺, is quantified by an ICP emission spectrometry, whereupon the reducing state is measured by obtaining the amount of Fe²⁺/total amount of Fe ions (Fe²⁺+Fe³⁺).

The glass plate for a display substrate of the present invention is a silicate glass and contains, as essential components, in addition to SiO₂, Al₂O₃, at least one member selected from the group consisting of Li₂O, Na₂O and K₂O, and at least one member selected from the group consisting of Ti, Mn, Zn, Y, Nb, La, Ce and W.

Now, glass components for the glass plate for a display substrate of the present invention and their content proportions will be described, as represented by mass % (which will be represented simply by %).

The glass plate for a display substrate of the present invention preferably consists essentially of, as calculated as oxides, from 45 to 72% of SiO₂, from 0 to 15% of Al₂O₃, from 6 to 24% of Li₂O+Na₂O+K₂O, from 0 to 10% of BaO, from 4 to 31% of MgO+CaO+SrO+BaO, from 0 to 10.5% of ZrO₂, and from 0.1 to 10% of TiO₂+MnO₂+ZnO+Y₂O₃+Nb₂O₅+La₂O₃+CeO₂+WO₃.

SiO₂ is a network former and preferably contained in an amount of at least 45%. The content of SiO₂ is more preferably at least 50%, further preferably at least 55%. On the other hand, if the content of SiO₂ exceeds 72%, the expansion coefficient tends to be too small, and the content is preferably at most 72%, more preferably at most 70%.

Al₂O₃ is a component to increase Tg. The content of Al₂O₃ is more preferably at least 2%, further preferably at least 3%. Further, the content is preferably at most 15%. If the content of Al₂O₃ exceeds 15%, the viscosity of the molten glass tends to be too high, and forming of a glass plate by a float process tends to be difficult. The content is more preferably at most 12%.

Li₂O, Na₂O and K₂O are components to lower the viscosity of the molten glass or to increase the expansion coefficient. It is preferred that at least one member selected from the group consisting of Li₂O, Na₂O and K₂O is contained. The content of such Li₂O, Na₂O and K₂O i.e. the total content of Li₂O+Na₂O+K₂O, is preferably from 6 to 24%. If the total content of these components is less than 6%, it tends to be difficult to bring the expansion coefficient within the desired range, or the viscosity of the molten glass tends to be too high. The total content of these components is preferably at least 7%, more preferably at least 8%. On the other hand, if the total content exceeds 24%, the above-mentioned yellowing tends to be strong or the chemical durability and/or electrical insulating property tends to deteriorate. The total content is preferably at most 22%, more preferably at most 20%. Here, the reason as to why the yellowing is intensified by these three components is considered to be such that diffusion of Ag ions is accelerated by mutual diffusion of Li, Na and K.

Oxides of at least one member selected from the group consisting of Ti, Mn, Zn, Y, Nb, La, Ce and W are components to suppress formation of silver colloid, and at least one type of such oxides is preferably contained. The total amount of oxides of at least one member selected from the group consisting of Ti, Mn, Zn, Y, Nb, La, Ce and W, i.e. the total content of TiO₂+MnO₂+ZnO+Y₂O₃+Nb₂O₅+La₂O₃+CeO₂+WO₃ is preferably from 0.1 to 10%. Preferably, oxides of at least one member selected from the group consisting of Ti, Mn, Zn, Y, Nb, La, Ce and W are contained. Further preferably oxides of at least one member selected from the group consisting of Mn, Y, Nb, Ce and W, are contained, particularly preferably oxides of at least one member selected from the group consisting of Mn, Y, Nb and W, are contained. Most preferably an oxide of Y is contained. If the proportion of the total content of these components is less than 0.1%, there may be a case where yellowing by silver colloid cannot be suppressed. The total content of these components is more preferably at least 0.3%, further preferably at least 0.5%, particularly preferably at least 0.8%. On the other hand, if the total content exceeds 10%, the amount of these components in the starting material for melting glass tends to be too large, and consequently, the melting property of the glass tends to deteriorate. The total content is preferably at most 10%, more preferably at most 7%, particularly preferably at most 5%.

Any one of MgO, CaO, SrO and BaO is not essential, but is effective to lower the viscosity of the molten glass. It is preferred that at least one member selected from the group consisting of MgO, CaO, SrO and BaO is contained. The content of such MgO, CaO, SrO and BaO, i.e. the total content of MgO+CaO+SrO+BaO, is preferably from 4 to 31%. If such components are too much, the specific gravity tends to increase. Accordingly, the proportion of the total content of MgO, CaO, SrO and BaO is preferably at most 31%, more preferably at most 27%, particularly preferably at most 25%. On the other hand, the proportion of the total content is preferably at least 5%, more preferably at least 8%, particularly preferably at least 10%.

ZrO₂ is not essential, but may be incorporated up to 10% to increase Tg. If the content of ZrO₂ exceeds 10%, the specific gravity tends to be too large. The content is preferably at most 7%, more preferably at most 4%.

In preferred embodiments, the glass or the glass plate for a display substrate of the present invention consists essentially of the above-described components, but may contain other components within a range not to impair the purpose of the present invention. The proportion of the total content of such other components is preferably at most 20%, more preferably at most 10%, particularly preferably at most 5%. Such other components may be exemplified as follows.

In order to color the glass, the coloring component such as Fe₂O₃, NiO or CoO may be incorporated. The proportion of the total content of such coloring components is at most 1%. SO₃, Cl, F, SnO₂, AS₂O₃ or Sb₂O₃ may, for example, be incorporated as a component to improve the melting property, clarification or forming property of the glass. In the case of a glass plate for a display substrate for PDP or FED, SO₃ is preferred when the quality of display, harmfulness, etc. are taken into consideration.

The proportion of the total content of these components is preferably at most 3%.

In the case of a glass plate for a display substrate for PDP or FED, if the glass contains a halogen, a degassing phenomenon is likely to take place in the vacuum evacuation step in the process for producing PDP or FED, whereby the quality of display will substantially be lowered. Accordingly, in such an application, it is preferred that substantially no halogen is incorporated.

The glass plate for a display substrate of the present invention is produced, for example, as follows. Starting materials which are commonly used, are mixed to have the desired composition, and the mixture is heated and melted in a melting furnace at a temperature of from 1,500 to 1,600° C. After homogenizing the glass by e.g. bubbling, addition of a clarifier or stirring, it is formed in a prescribed plate thickness by a well-known float process, then annealed and cut into a prescribed size to obtain a glass substrate. Of course, the plate glass may be produced by a plate glass forming method other than a float process. With a front glass substrate of PDP, it is considered as mentioned above that Ag ions diffused from bus electrodes into the glass substrate, are reduced by Fe²⁺, Sn²⁺, etc. present in the diffused layer to Ag⁰, and colloid formed by aggregation of such Ag⁰ will bring about yellowing. In the surface of the float plate glass, ions of Fe²⁺, Sn²⁺, etc., will be present in a larger amount, as the surface of the plate glass is exposed to a reducing atmosphere during the production step by a float process. Accordingly, yellowing takes place more distinctly in a layer having a high reducing state, and it is preferred that the thickness (the depth) of such a layer in the float plate gas is thin. Specifically, the thickness of such a layer is preferably at most 50 μm, more preferably at most 30 μm, most preferably at most 25 μm, from the surface of the glass plate. In such a layer of at most 50 μm, at most 30 μm, or at most 25 μm, from the surface of the glass plate, the reducing state of glass in such a surface layer is higher than the reducing state of glass inside of such a surface layer. The same applies even to a glass plate prepared by a process for producing a plate glass other than the float process, so long as it is glass plate wherein the reducing state of glass on the surface side is higher than the reducing state of glass inside thereof.

In the present invention, the glass plate for a display substrate contains oxides of at least one member selected from the group consisting of Ti, Mn, Zn, Y, Nb, La, Ce and W. Such oxides have an effect to suppress formation of silver colloid. Accordingly, the glass plate for a display substrate of the present invention is useful as a glass plate for a front glass substrate for PDP, which is particularly susceptible to yellowing.

Further, the glass plate for a display substrate of the present invention is useful also as a glass plate for a front glass substrate for FED. Further, it is useful also as a glass substrate for a front glass substrate for other displays.

### EXAMPLES

Raw materials were mixed to have a composition shown by mass % in the lines of from “SiO₂” to “TiO₂” in Table 1 and melted at a temperature of from 1,550 to 1,600° C. by means of a platinum crucible. Then, molten glass was poured out and formed into a plate, followed by annealing. In this manner, nine types of glass plates were obtained. From each glass plate, a mirror-polished glass plate having a thickness of 2.8 mm was prepared. With respect to this glass plate, the specific gravity was measured by an Archimedes method, and the expansion coefficient (unit:10⁻⁷/° C.) was measured by a differential thermal expansion meter. Further, from the bending point of the expansion curve obtained by the differential thermal expansion meter, Tg (unit:° C.) was read-out. The results are shown in Table 1. Examples 1 to 4 and 6 to 8 represent examples of the present invention, and Examples 5 and 9 are comparative examples.

TABLE 1

| | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| SiO₂ | 58 | 58 | 58 | 58 | 58 | 60 | 60 | 60 | 60 |
| Al₂O₃ | 7 | 7 | 7 | 7 | 7 | 10 | 10 | 10 | 10 |
| Na₂O | 4 | 4 | 4 | 4 | 4 | 5 | 5 | 5 | 5 |
| K₂O | 6 | 6 | 6 | 6 | 6 | 10 | 10 | 10 | 10 |
| MgO | 2 | 2 | 2 | 2 | 2 | 5 | 5 | 5 | 5 |
| CaO | 5 | 5 | 5 | 5 | 5 | 6 | 6 | 6 | 6 |
| SrO | 7 | 7 | 7 | 7 | 7 | 2 | 2 | 2 | 2 |
| BaO | 8 | 8 | 8 | 8 | 8 | 0 | 0 | 0 | 0 |
| ZrO₂ | 3 | 3 | 3 | 3 | 3 | 2 | 2 | 2 | 2 |
| Fe₂O₃ | 0.08 | 0.08 | 0.08 | 0.08 | 0.08 | 0.13 | 0.13 | 0.13 | 0.13 |
| MnO₂ | 0 | 0 | 0 | 0 | 0 | 0 | 0.1 | 0 | 0 |
| Y₂O₃ | 0.5 | 1 | 0 | 0 | 0 | 0 | 0 | 0 | 0 |
| Nb₂O₃ | 0 | 0 | 1 | 0 | 0 | 0 | 0 | 0 | 0 |
| CeO₂ | 0 | 0 | 0 | 0 | 0 | 0.1 | 0 | 0 | 0 |
| WO₃ | 0 | 0 | 0 | 1 | 0 | 0 | 0 | 0 | 0 |
| TiO₂ | 0 | 0 | 0 | 0 | 0 | 0 | 0 | 0.1 | 0 |
| Specific | 2.77 | 2.77 | 2.77 | 2.77 | 2.77 | 2.56 | 2.56 | 2.56 | 2.56 |
| gravity | | | | | | | | | |
| Expansion | 84 | 84 | 84 | 84 | 84 | 84 | 84 | 84 | 84 |
| coefficient | | | | | | | | | |
| Tg | 635 | 635 | 635 | 685 | 635 | 640 | 640 | 640 | 640 |

Using such a glass plate, the following reduction heat treatment was carried out to simulate a glass plate formed by a float process i.e. a float plate glass. Each mirror-polished glass plate having a thickness of 2.8 mm was heated to 725° C. for 90 minutes in a reducing atmosphere comprising 10% of hydrogen and 90% of nitrogen as represented by volume percentage. It was held in such an atmosphere at 725° C. for 5 hours and then cooled to room temperature.

With respect to the glass plates of Examples 1 to 5, the distribution of Fe²⁺ concentration in the glass surface was examined by a dipyridyl absorptionmetry and ICP emission spectrometry, and the reducing state in the thickness direction of the glass plate was examined, whereby it was found to be 76% in a depth of from 0 to 25 μm from the surface of the glass, 57% in a depth of from 26 to 50 μm and 24% in a depth of from 51 to 85 μm, thus showing that as compared with the inside of the glass, a layer having a high reducing state was present in a surface layer in a depth of about 50 μm from the surface of glass.

On one side of each glass plate subjected to reduction heat treatment, a silver paste (trade name: Dotite D-550, manufactured by Fujikura Kasei K.K.) was applied in the atmospheric air. Then, also in the atmospheric air, it was heated to 580° C. at a temperature raising rate of 200° C./hr and then fired at 580° C. for one hour. Then, it was cooled at a temperature-lowering rate of 60° C./hr.

Then, the fired silver film on the glass plate thus fired, was removed by nitric acid having a concentration of 20% as represented by weight percentage.

The absorbances were measured before and after the silver firing treatment of the glass plate having a thickness of 2.8 mm by a self-recording spectrophotometer (trade name: U-3500, manufactured by Hitachi Seisakusho K.K.).

From the absorbance value of each sample after the silver firing treatment, value b* was obtained by the method disclosed by JIS Z 8729(1994) and taken as an index for the yellowing degree. b* in Examples 1 to 4 was 4.9, 3.5, 6.7 and 7.2, respectively, and b* in Comparative Example 5 was 8.3. b* in Examples 1 to 4 was small as compared with Comparative Example 5, thus showing that yellowing was suppressed. Likewise, b* in Examples 6 to 8 was small as compared with Comparative Example 9, thus showing that the yellowing was suppressed. The effect for suppressing yellowing is highest with Y₂O₃.

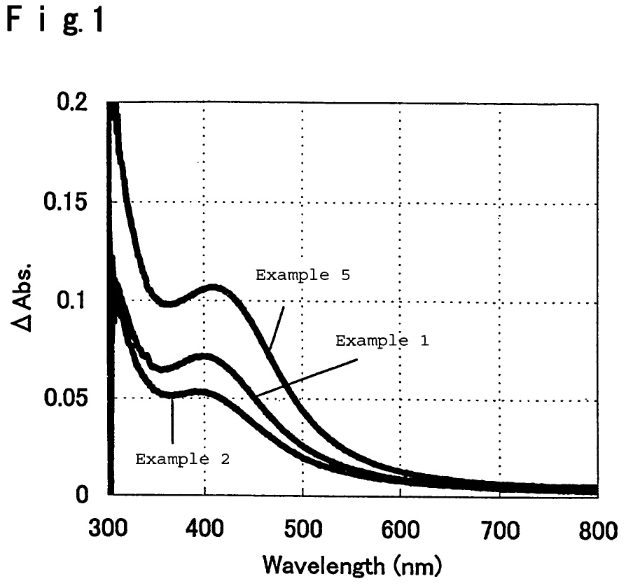

With respect to Examples 1, 2 and 5, the difference in absorbance before and after the silver firing treatment was calculated, and the results are shown in FIG. 1.

The absorption peak in the vicinity of 410 nm is one attributable to silver colloid. As is evident from FIG. 1, absorption peaks in Example 1 and 2 are small as compared with Example 5, thus showing that yellowing is remarkably suppressed.

### INDUSTRIAL APPLICABILITY

The glass substrate for display of the present invention has an effect such that even if a silver paste is applied and fired on the glass substrate for display in the process for producing PDP or FED, yellowing due to silver at the portion coated with the silver paste will not take place, or such yellowing is little. Such a glass substrate is useful, since in a flat panel display for PDP or FED wherein such a glass substrate is employed, an image of high quality is obtainable free from yellowing.

The entire disclosure of Japanese Patent Application No. 2003-155027 filed on May 30, 2003 including specification, claims, drawing and summary is incorporated herein by reference in its entirety.

What is claimed is:

1. A glass plate for a display substrate, which contains at least one member selected from the group consisting of Ti, Mn, Zn, Y, Nb, La, Ce and W in an amount of from 0.1 to 10 mass % as calculated as oxides.

2. The glass plate for a display substrate according to claim 1, which contains at least one member selected from the group consisting of Mn, Y, Nb, Ce and W in an amount of from 0.1 to 10 mass % as calculated as oxides.

3. The glass plate for a display substrate according to claim 1, which contains at least one member selected from the group consisting of Mn, Y, Nb and W in an amount of from 0.1 to 10 mass % as calculated as oxides.

4. The glass plate for a display substrate according to claim 1, which is a glass plate formed by a float process.

5. The glass plate for a display substrate according to claim 1, which is a silicate glass and contains at least one member selected from the group consisting of Li₂O, Na₂O and K₂O in a total amount of from 6 to 24 mass %.

6. The glass plate for a display substrate according to claim 1, which has a glass transition point of at least 580° C.

7. The glass plate for a display substrate according to claim 1, wherein the reducing state of glass at the surface layer in a depth of 50 μm from the surface of the glass plate is higher than the reducing state of glass inside of the surface layer.

8. The glass plate for a display substrate according to claim 1, which is a glass plate consisting essentially of, as represented by mass %, from 45 to 72% of SiO₂, from 0 to 15% of Al₂O₃, from 6 to 24% of Li₂O+Na₂O+K₂O, from 4 to 31% of MgO+CaO+SrO+BaO, from 0 to 10.5% of ZrO₂, and from 0.1 to 10% of TiO₂+MnO₂+ZnO+Y₂O₃+Nb₂O₅+La₂O₃+CeO₂+WO₃.

9. The glass plate for a display substrate according to claim 1, which is a glass plate for a display substrate, for PDP or FED.
